(19) United States
(12) Patent Application Publication
(10) Pub. No.: US 2025/0222453 A1
(43) Pub. Date: Jul. 10, 2025

(54) REAL-TIME FLOW CYTOMETRIC ANALYZER OF SINGLE-CELL DYNAMICS COMBINING DROPLET MICROFLUIDICS AND MULTIMODAL OPTICAL MICROSCOPY

(71) Applicant: DALIAN UNIVERSITY OF TECHNOLOGY, Dalian (CN)

(72) Inventors: Kairong QIN, Dalian (CN); Siyu HU, Dalian (CN); Likai HOU, Dalian (CN); Hsiangchen CHUI, Dalian (CN); Yongjiang LI, Dalian (CN); Guiyang XIN, Dalian (CN); Chundong XUE, Dalian (CN); Xuqu HU, Dalian (CN); Shanshan LI, Dalian (CN)

(21) Appl. No.: 19/093,567

(22) Filed: Mar. 28, 2025

(30) Foreign Application Priority Data
May 10, 2024 (CN) 202410571830.3

(51) Int. Cl. B01L 3/00

(52) U.S. Cl. CPC B01L 3/502761; B01L 3/502715; B01L 2200/0647; B01L 2200/16; B01L 2300/0654; B01L 2300/088; B01L 2300/14

(57) ABSTRACT

The present invention provides a real-time flow cytometric analyzer of single-cell dynamics combining droplet microfluidics and multimodal optical microscopy, and belongs to the field of cell biology experimental devices. The analyzer comprises a cell/signal loading & acquisition and control system, a high-throughput microfluidic single-cell manipulation chip, a multi-channel optical microscopy and multimodal signal acquisition and control system, and a data processing and analysis system. Based on droplet-based microfluidic chip technology, multimodal optical microscopy technology, single-cell dynamics theoretical modeling and analysis methods, and artificial intelligence technology, the integrated detection of spatiotemporal information of single-cell dynamics can be realized. The analyzer provides a new rapid and accurate single-cell dynamics analysis platform for exploring the occurrence and development mechanism of major human diseases, disease diagnosis, cell sorting and drug screening, etc.

### TECHNICAL FIELD

The present invention belongs to the field of cell biology experimental devices. It is a micro-total analysis system (μTAS) for integrated detection of spatiotemporal information of single-cell dynamics developed on the basis of the droplet-based microfluidic chip technology, the multimodal optical microscopy technology, the theoretical modeling and analytical method for single-cell dynamics and the artificial intelligence technology. Specifically, it is a real-time flow cytometric analyzer of single-cell dynamics combining droplet microfluidics and multimodal optical microscopy.

### BACKGROUND

Cells in vivo exist in a complex dynamic flow microenvironment composed of surrounding tissue cells, intercellular matrix and bodily fluid. Cells are not only stimulated by mechanical force signals in the microenvironment, but also synergistically stimulated by concentration signals of biochemical factors such as hormones and neurotransmitters in the microenvironment. Cells can identify mechanical and biochemical signals from the extracellular flow microenvironment, transduce and transmit extracellular signals into the interior of the cell through various signal pathways, causing changes in the concentrations of intracellular second messengers such as calcium ions (Ca²⁺), reactive oxygen species (ROS) and nitric oxide (NO). And a series of downstream cell biology events are regulated through the interaction between signaling molecules, presenting multi-scale time and space (hereinafter referred to as spatiotemporal) nonlinear dynamic responses which are closely related to functions and behaviors such as cell division, differentiation, proliferation and apoptosis.

Cells in vivo face an extremely complex extracellular microenvironment with many uncontrollable interference factors. In vitro research can largely exclude interference factors and is currently recognized as a feasible research method in this field. Based on technologies such as atomic force microscopy, optical tweezers, micropipette aspiration or parallel-plate flow chamber, combined with classical methods of cell molecular biology, researchers have constructed a relatively complete research system of cellular biomechanics and cellular mechanobiology. However, most of the existing in vitro research systems mainly focus on the offline analysis of molecular omics and markers, morphology, subcellular structure and organelle functions of cells stimulated by mechanical and/or biochemical signals. It is impossible to synchronously observe the influence of internal and external environmental factors on the cellular structure, functions and overall behaviors as well as the dynamic changes and interactions of various intracellular signaling molecules in real time in a single experiment. Therefore, it is urgent to develop new detection and analysis instrumentation to construct a new in vitro research system, and establish a more accurate extracellular mechanical and biochemical signal loading technology and device in combination with an accurate measurement technology and system of single-cell multimodal spatiotemporal information.

### SUMMARY

The present invention designs and constructs a novel microfluidic chip based on the micro/nanofluidic principle, which solves the problems of accurate loading of mechanical and biochemical signals and mismatch of the time scale of mechanical and biochemical signal dynamic response; realizes integrated measurement of spatiotemporal information of various mechanical and biochemical factors by the multi-channel optical microscopy technology; establishes a new deep neural network learning method combining single-cell mechanics and signal dynamics mechanism information, and conducts real-time analysis of single-cell mechanical properties and intracellular signal dynamics characteristic parameters directly based on the dynamic images of single-cell deformation and concentration fields of intracellular and extracellular biochemical substances; and on this basis, develops a single-cell dynamics analyzer prototype and carries out biomedical application researches, providing a new single-cell dynamics analytical instrument for exploring the occurrence and development mechanism of major human diseases, disease diagnosis, cell sorting and drug screening, etc.

The present invention has the following technical solution:

A real-time flow cytometric analyzer of single-cell dynamics combining droplet microfluidics and multimodal optical microscopy, wherein the real-time flow cytometric analyzer of single-cell dynamics comprises a cell/signal loading & acquisition and control system I, a high-throughput microfluidic single-cell manipulation chip II, a multi-channel optical microscopy and multimodal signal acquisition and control system III, and a data processing and analysis system IV.

The cell/signal loading & acquisition and control system I comprises an industrial control computer 2-1, a pressure actuated device 2-2, a liquid storage bottle A2-3A, a liquid storage bottle B2-3B, a liquid storage bottle C2-3C, a micro flow measurement module A2-4A, a micro flow measurement module B2-4B and a micro flow measurement module C2-4C. The industrial control computer 2-1 is used for controlling the pressure actuated device 2-2 and displaying flow data loaded in the micro flow measurement module A2-4A, the micro flow measurement module B2-4B and the micro flow measurement module C2-4C; The pressure actuated device 2-2 is respectively connected with the liquid storage bottle A2-3A, the liquid storage bottle B2-3B and the liquid storage bottle C2-3C, and the outlets of the liquid storage bottle A2-3A, the liquid storage bottle B2-3B and the liquid storage bottle C2-3C are respectively connected with the micro flow measurement module A2-4A, the micro flow measurement module B2-4B and the micro flow measurement module C2-4C for detecting and feeding back the flow input loaded by the industrial control computer 2-1 to the industrial control computer 2-1. The outlets of the micro flow measurement module A2-4A, the micro flow measurement module B2-4B and the micro flow measurement module C2-4C are respectively connected with an oil phase inlet 3-1A, a biochemical factor buffer solution inlet 3-1B and a single-cell suspension inlet 3-1C.

The high-throughput microfluidic single-cell manipulation chip II comprises an oil phase inlet 3-1A, a biochemical factor buffer solution inlet 3-1B, a single-cell suspension inlet 3-1C, a spiral inertial focusing microchannel 3-2, a constrained narrow channel array 3-3 and a chip outlet 3-4. The oil phase inlet 3-1A, the biochemical factor buffer solution inlet 3-1B and the single-cell suspension inlet 3-1C are converged to a cruciform outlet through respective channels and connected with the inlet of the spiral inertial focusing microchannel 3-2, the outlet of the spiral inertial focusing microchannel 3-2 is connected with the inlet of the constrained narrow channel array 3-3, and the outlet of the constrained narrow channel array 3-3 is the chip outlet 3-4.

A single-cell suspension channel connected after the single-cell suspension inlet 3-1C is composed of a plurality of anticlockwise spiral inertial focusing microchannels, and single cells are sequenced under the action of centrifugal force and fluidic shear stress in the process of single-cell suspension passing through the single-cell suspension channel; the biochemical factor buffer solution inlet 3-1B and a circular biochemical factor buffer solution channel connected thereafter are located on the outer ring of the single-cell suspension channel, and the biochemical factor buffer solution inlet 3-1B is symmetrically arranged with the outlet of the circular biochemical factor buffer solution channel; and the oil phase inlet 3-1A and a circular oil phase channel connected thereafter are located on the outer ring of the circular oil phase channel, and the oil phase inlet 3-1A is symmetrically arranged with the outlet of the circular oil phase channel. The outlet of the single-cell suspension channel is located in front of the outlet of the circular biochemical factor buffer solution channel, which enables single cells from the outlet of the single-cell suspension channel to mix with biochemical factor buffer solution, and the outlet of the circular biochemical factor buffer solution channel is located in front of the outlet of the circular oil phase channel, which enables the mixture of single cells from the outlet of the circular biochemical factor buffer solution channel and the biochemical factor buffer solution to be encapsulated by an oil phase.

Further, the single-cell suspension inlet 3-1C is located in the center of the single-cell suspension channel, and the single-cell suspension channel is spiraled from the inside out.

Further, the front segment of the constrained narrow channel array 3-3 is a chamber with a gradually increasing caliber, the rear segment is a chamber with a gradually decreasing caliber, and the middle segment is composed of constrained narrow channels arranged in an array in parallel; and the caliber of each constrained narrow channel gradually decreases from inlet to outlet, and the width of the middle narrow section is less than the average cell diameter and then gradually becomes larger.

The multi-channel optical microscopy and multimodal signal acquisition and control system III comprises an industrial control computer 2-1 and a multi-channel fluorescence microscope 4-1, and the industrial control computer 2-1 is used for measuring multimodal information of single cells and controlling the multi-channel fluorescence microscope 4-1, comprising an image collection module, an image display module, an electric table control module and a laser control module.

Further, the image collection module is used for collecting images in the field of the multi-channel fluorescence microscope 4-1, the image display module is used for displaying the collected images, the electric table control module is used for adjusting the shooting position of the multi-channel fluorescence microscope 4-1, and the laser control module is used for switching lasers with different wavelengths.

The data processing and analysis system IV comprises an image data processing module and a data analysis and display module loaded in the industrial control computer 2-1, wherein the image data processing module comprises a cell morphometry analysis module, a cellular mechanodynamic modeling module and a single-cell kinetic modeling module; and the data analysis and display module comprises a neural network-based multimodal information fusion unit, a data display interface unit and a pressure/flow control interface unit.

Further, the cell morphometry analysis module is used for calculating the degree of cell deformation and the time to pass through the constrained narrow channel array 3-3 and calculating the cellular elastic modulus and viscous modulus; the cellular mechanodynamic modeling module is used for establishing a single-cell mechano-viscoelastic model; the single-cell kinetic modeling module uses parameter identification methods to acquire changes in the concentrations of intracellular second messengers and establish an intracellular second messenger dynamics model; the neural network-based multimodal information fusion unit combines the structures of a convolutional neural network (CNN) and a recurrent neural network (RNN) to construct a deep neural network framework, and selects specific multimodal imaging data and neural network structure according to extraction requirements of different features; and the data display interface unit displays the obtained data on the industrial control computer 2-1.

Further, the cell/signal loading & acquisition and control system I has the function of accurate and quantitative loading of biochemical signals. The flow of the single-cell suspension and the biochemical factor buffer solution can be accurately regulated by the pressure actuated device 2-2, thereby obtaining mixed droplets of biochemical factors and single cells with different concentrations to achieve accurate and quantitative loading of biochemical signals. At the moment of droplet formation, a step signal is loaded into the encapsulated single cells for stimulation, and after droplet formation, the concentration of the biochemical factors is not affected by the change of external flow, so as to ensure that the cells in the encapsulated micro-droplets are subjected to biochemical stimulation with a specific concentration and improve the detection accuracy. Meanwhile, in order to avoid the mismatch of flow and pressure between the forward channel and the outlet of the microfluidic chip and ensure accurate loading of single-cell droplet encapsulation and concentration gradient biochemical signals and full-process reliability of high-throughput spatiotemporal detection in constrained narrow channels, a micro flow measurement module A2-4A, a micro flow measurement module B2-4B and a micro flow measurement module C2-4C are arranged in front of the inlet of each chip channel to ensure accurate loading of mechanical and biochemical signals.

Further, the high-throughput microfluidic single-cell manipulation chip II has the functions of single-cell high-throughput encapsulation and uniform mixing. In the high-throughput encapsulation portion of single cells, a classical cruciform droplet formation structure is adopted, that is, the junction of the oil phase inlet 3-1A, the biochemical factor buffer solution inlet 3-1B and the single-cell suspension inlet 3-1C. The constrained narrow channel array can squeeze the single cells to make the passing single cells deform, and the multi-channel optical microscopy and multimodal signal acquisition and control system III collects images to measure single-cell mechanics information and intracellular dynamics information. In the multi-channel optical microscopy and multimodal signal acquisition and control system III, the industrial control computer 2-1 comprises an image collection module, an image display module, an electric table control module and a laser control module. The image collection module and the image display module are responsible for collecting and displaying images. The electric table control module and the laser control module are responsible for adjusting the shooting position and switching lasers with different wavelengths.

Further, the data processing and analysis system IV processes, analyzes and displays images containing single-cell mechanics information and intracellular dynamics information measured by the multi-channel optical microscopy and multimodal signal acquisition and control system III. The image data processing module is responsible for processing and analyzing the images containing single-cell mechanics information and intracellular dynamics information. The cell morphometry analysis module calculates the degree of cell deformation and the time to pass through the constrained narrow channel array 3-3, and calculates the cellular elastic modulus and viscous modulus from the obtained degree of cell deformation and the time to pass through the constrained narrow channel array 3-3; the cellular mechanodynamic modeling module establishes a single-cell mechano-viscoelastic model based on the data obtained from the cell morphometry analysis module; and the single-cell kinetic modeling module uses parameter identification methods such as system identification and model parameters to acquire the changes in the concentrations of intracellular second messengers (for example, Ca²⁺, ROS and NO) and establish a single-cell Ca²⁺/ROS/NO dynamics model. The data analysis and display module is responsible for further analyzing and displaying the data obtained from the image data processing module. The neural network-based multimodal information fusion unit refers to typical neural network design ideas, combines the structures of a CNN and a RNN to construct a deep neural network framework, and selects specific multimodal imaging data and neural network structure according to extraction requirements of different features. For example, based on the data of the cell dynamic deformation process, cell mechanics characteristic parameters are extracted by the recurrent neural network; and based on the dynamic fluorescence response images of the second messengers, the characteristic parameters transduced by cell signals are extracted. The output results of different deep neural network modules are input into a neural network with a fully connected layer as multi-dimensional cell characteristic data, realizing rapid acquisition of single-cell mechanical properties and signal dynamics characteristic parameters through comprehensive analysis of multimodal optical imaging data. The data display interface unit displays the obtained data on the industrial control computer 2-1 so that users can see the sample information at a glance. The pressure/flow control interface unit displays and controls the pressure waveform set by the pressure actuated device 2-2 and the flow waveform detected by the micro flow measurement module A2-4A, the micro flow measurement module B2-4B and the micro flow measurement module C2-4C in the cell/signal loading & acquisition and control system I.

A real-time analytical method for single-cell dynamics using the above real-time flow cytometric analyzer of single-cell dynamics combining droplet microfluidics and multimodal optical microscopy, comprising the following steps:

Step 1: preparing glycerite, biochemical factor buffer solution and single-cell suspension, and placing in the liquid storage bottle A2-3A, the liquid storage bottle B2-3B and the liquid storage bottle C2-3C respectively. Controlling the pressure actuated device 2-2 through the pressure/flow control interface unit in the industrial control computer 2-1 to inject the glycerite, the biochemical factor buffer solution and the single-cell suspension into the oil phase inlet 3-1A, the biochemical factor buffer solution inlet 3-1B and the single-cell suspension inlet 3-1C of the high-throughput microfluidic single-cell manipulation chip II respectively at different flow velocities through the micro flow measurement module A2-4A, the micro flow measurement module B2-4B and the micro flow measurement module C2-4C. The single-cell suspension is orderly arranged through a plurality of anticlockwise spiral inertial focusing microchannels, the biochemical factor buffer solution passes through the circular channel, and the glycerite passes through the circular channel, which are then converged to a cruciform outlet to orderly form droplets encapsulating single cells. In the spiral inertial focusing microchannel 3-2 connected thereafter, the single cells in the droplets and the biochemical factor buffer solution are uniformly mixed and orderly arranged, and the droplets encapsulating the single cells are orderly arranged to deform through the constrained narrow channel array 3-3 and then flow out from the chip outlet 3-4.

Step 2: switching on the multi-channel optical microscopy and multimodal signal acquisition and control system III, adjusting the position of the multi-channel fluorescence microscope 4-1 using the electric table control module in the industrial control computer 2-1, and using the laser control module to switch between the bright field and the laser to take, record and collect images. Using the image collection module in the industrial control computer 2-1 for real-time monitoring of the deformation process and transit time of single cells in the constrained narrow channel array 3-3 and the changes in the concentrations of intracellular Ca²⁺/ROS/NO and for display in the image display module.

Step 3: according to the images taken, recorded and collected by the multi-channel optical microscopy and multimodal signal acquisition and control system III, using the image data processing module for data processing in the data processing and analysis system IV: using the cell morphometry analysis module to analyze the deformation process and transit time of single cells passing through the constrained narrow channel array 3-3, and calculating the cellular elastic modulus and viscous modulus. Using the cellular mechanodynamic modeling module to establish a single-cell mechano-viscoelastic model. Using the single-cell kinetic modeling module to calculate the changes in the concentrations of intracellular second messengers and establish an intracellular second messenger dynamics model. Using the data analysis and display module for data analysis and display in the data processing and analysis system IV: using the neural network-based multimodal information fusion unit for deep learning of the obtained cell mechanics information and dynamics information via the neural network to obtain a neural network-based multimodal information model, preparing for subsequent rapid analysis of multimodal information of single cells, and realizing intelligent analysis of single cells. Using the data display interface unit to display all data results.

Step 4: loading random blood samples into the real-time flow cytometric analyzer of single-cell dynamics, and obtaining multimodal information of single cells in the samples by the neural network-based multimodal information fusion unit for distinguishing normal cells from cancer cells. Converting the biochemical factor buffer solution into a drug, loading the drug into cells, and repeating steps 1-4, thereby performing drug screening according to the obtained multimodal information of single cells.

The present invention has the following beneficial effects: the present invention can realize cooperative loading of mechanical and biochemical signals of single cells encapsulated by flowing droplets, realize real-time detection of single-cell dynamic deformation, extracellular mechanical and biochemical signals and intracellular dynamic spatiotemporal signals, and conducts real-time analysis of single-cell mechanical properties and intracellular signal dynamics feature parameters directly based on the dynamic images of single-cell deformation and concentration fields of intracellular and extracellular biochemical substances by establishing a new deep neural network learning method combining single-cell mechanics and signal dynamics mechanism information. The successful implementation of the present invention will provide a new single-cell dynamics analytical instrument for exploring the occurrence and development mechanism of major human diseases, disease diagnosis, cell sorting and drug screening, etc.

### DESCRIPTION OF DRAWINGS

FIG. 1 is an overall structure of the instrument.

FIG. 2 is a schematic diagram of a cell/signal loading & acquisition and control system.

FIG. 3 is a schematic diagram of a high-throughput microfluidic single-cell manipulation chip.

FIG. 4 is a schematic diagram of a multi-channel optical microscopy and multimodal signal acquisition and control system;

FIG. 5 is a schematic diagram of a data processing and analysis system.

In the figures: I cell/signal loading & acquisition and control system; II high-throughput microfluidic single-cell manipulation chip; III multi-channel optical microscopy and multimodal signal acquisition and control system; IV data processing and analysis system; 2-1 industrial control computer; 2-2 pressure actuated device; 2-3A liquid storage bottle A; 2-3B liquid storage bottle B; 2-3C liquid storage bottle C; 2-4A micro flow measurement module A; 2-4B micro flow measurement module B; 2-4C micro flow measurement module C; 3-1A oil phase inlet; 3-1B biochemical factor buffer solution inlet; 3-1C single-cell suspension inlet; 3-2 spiral inertial focusing microchannel; 3-3 constrained narrow channel array; 3-4 chip outlet; 4-1 multi-channel fluorescence microscope.

### DETAILED DESCRIPTION

The technical solution of the present invention is further described below in combination with specific embodiments and drawings.

A real-time flow cytometric analyzer of single-cell dynamics combining droplet microfluidics and multimodal optical microscopy, as shown in FIG. 1, comprising a cell/signal loading & acquisition and control system I, a high-throughput microfluidic single-cell manipulation chip II, a multi-channel optical microscopy and multimodal signal acquisition and control system III, and a data processing and analysis system IV.

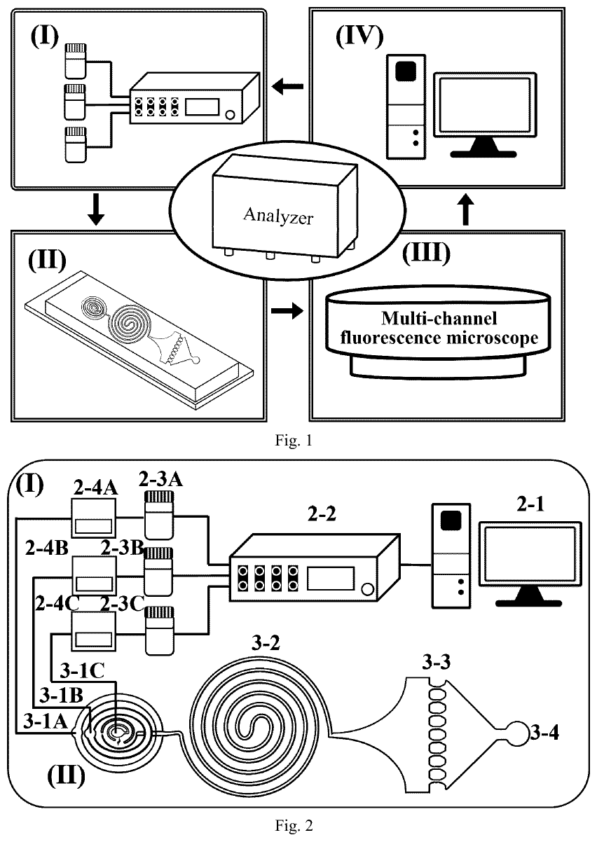

FIG. 2 shows the cell/signal loading & acquisition and control system I, mainly comprising an industrial control computer 2-1, a pressure actuated device 2-2, a liquid storage bottle A2-3A, a liquid storage bottle B2-3B, a liquid storage bottle C2-3C, a micro flow measurement module A2-4A, a micro flow measurement module B2-4B and a micro flow measurement module C2-4C. The micro flow measurement module A2-4A, the micro flow measurement module B2-4B and the micro flow measurement module C2-4C use thermally distributed micro flow sensors. The pressure actuated device 2-2 is composed of a pneumatic constant pressure pump and a pressure control program. The liquid storage bottle A2-3A contains glycerite, the liquid storage bottle B2-3B contains biochemical factor buffer solution, and the liquid storage bottle C2-3C contains single-cell suspension. The industrial control computer 2-1 controls the pressure actuated device 2-2, the pressure actuated device 2-2 is connected with the liquid storage bottle A2-3A, the liquid storage bottle B2-3B and the liquid storage bottle C2-3C, and the outlets of the liquid storage bottle A2-3A, the liquid storage bottle B2-3B and the liquid storage bottle C2-3C are respectively connected with the micro flow measurement module A2-4A, the micro flow measurement module B2-4B and the micro flow measurement module C2-4C for detecting and feeding back the flow input loaded by the industrial control computer 2-1 to the industrial control computer 2-1. The outlets of the micro flow measurement module A2-4A, the micro flow measurement module B2-4B and the micro flow measurement module C2-4C are respectively connected with an oil phase inlet 3-1A, a biochemical factor buffer solution inlet 3-1B and a single-cell suspension inlet 3-1C.

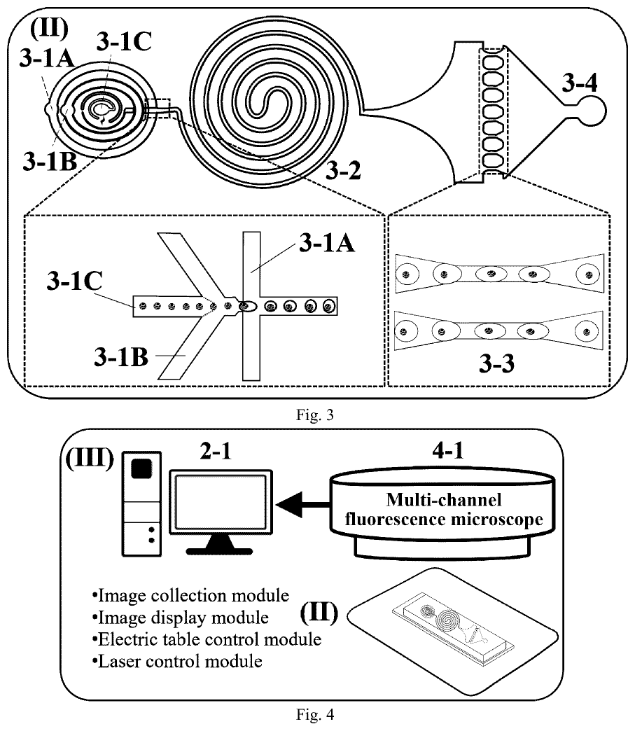

FIG. 3 shows the high-throughput microfluidic single-cell manipulation chip II, mainly comprising an oil phase inlet 3-1A, a biochemical factor buffer solution inlet 3-1B, a single-cell suspension inlet 3-1C, a spiral inertial focusing microchannel 3-2, a constrained narrow channel array 3-3 and a chip outlet 3-4. All the channel structures of the chip are made from PDMS using standardized micromachining methods, and are bonded and sealed with clean glass sheets to form a common glass-PDMS chip. In the present embodiment, all the channels inside the microfluidic chip are 150 μm in height, three inlets are 1.5 mm in width, and a classical cruciform droplet formation structure is adopted. The spiral inertial focusing microchannel 3-2 is 3 mm in width, and the constrained narrow channels in the constrained narrow channel array 3-3 are 10 μm in width and 200 μm in length. The chip outlet 3-4 is 1.5 mm in width.

FIG. 4 shows the multi-channel optical microscopy and multimodal signal acquisition and control system III, mainly comprising an industrial control computer 2-1 and a multi-channel fluorescence microscope 4-1. The industrial control computer 2-1 controls the multi-channel fluorescence microscope 4-1, comprising an image collection module, an image display module, an electric table control module and a laser control module.

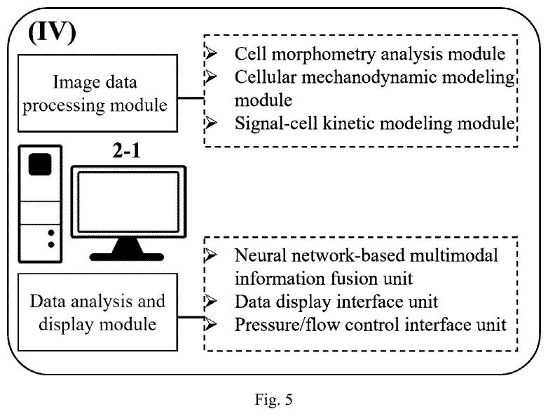

FIG. 5 shows the data processing and analysis system IV, mainly comprising an image data processing module and a data analysis and display module loaded in the industrial control computer 2-1, wherein the image data processing module comprises a cell morphometry analysis module, a cellular mechanodynamic modeling module and a single-cell kinetic modeling module; and the data analysis and display module comprises a neural network-based multimodal information fusion unit, a data display interface unit and a pressure/flow control interface unit. The cellular mechanodynamic modeling module calculates the cellular elastic modulus and viscous modulus through the cell morphometry analysis module according to the image data of the cell dynamic deformation process recorded by the multi-channel optical microscopy and multimodal signal acquisition and control system III, obtaining a single-cell mechano-viscoelastic model. Meanwhile, considering the interaction among the flow field, micro-droplets and cell deformation, the model is modified to be in line with the experimental results. Based on the constructed mechanical model, the relationship between the single-cell mechanical properties (elastic modulus and viscosity coefficient) and the dynamic deformation thereof is quantitatively analyzed to establish a calculation method for cell mechanical properties (elastic modulus and viscosity coefficient) based on the dynamic deformation process, so as to modify the calculation method for cell mechanical properties in the cell morphometry analysis module. The single-cell kinetic modeling module uses system identification and parameter identification methods to acquire the changes in the concentrations of intracellular second messengers and develops a mechanical-chemical information multi-field coupling theory based on the material transfer characteristics and biochemical reaction kinetics to obtain a cell signal dynamics model.

The analyzer is used for real-time cancer diagnosis and drug screening, as follows:

### Step 1: Accurate Loading of Mechanical and Biochemical Signal Stimulation

Placing glycerite, biochemical factor buffer solution and single-cell suspension in the liquid storage bottle A2-3A, the liquid storage bottle B2-3B and the liquid storage bottle C2-3C respectively, and using the industrial control computer 2-1 to control the pressure actuated device 2-2 to inject the glycerite, the biochemical factor buffer solution and the single-cell suspension into the oil phase inlet 3-1A, the biochemical factor buffer solution inlet 3-1B and the single-cell suspension inlet 3-1C of the high-throughput microfluidic single-cell manipulation chip II respectively at different flow velocities. The micro flow measurement module A2-4A, the micro flow measurement module B2-4B and the micro flow measurement module C2-4C detect the flow velocity of each channel in the middle and feeds back the flow velocity to the industrial control computer 2-1 to ensure accurate loading of biochemical signals. The solutions from the three channels pass through the respective spiral inertial focusing microchannels to the outlets for mixing, and form droplets encapsulating single cells and biochemical factor buffer solution with different concentrations at the final cruciform junction. The droplets are sequenced through the spiral inertial focusing microchannel 3-2 to make the single cells in the droplets react with biochemical factors for biochemical stimulation. Then the droplets pass through the constrained narrow channel array 3-3 to mechanically stimulate the single cells to deform. After that, the Fura-2,AM/RB-OPD/CellROX Deep Green probe is transfected into the single-cell suspension, and step 1 is repeated.

### Step 2: Image Collection and Display

Collecting and displaying spatiotemporal multimodal signals such as morphologic change and transit time of droplets encapsulating single cells to flow through the constrained narrow channel array 3-3 and changes in the concentrations of Ca²⁺/NO/ROS in combination with the image collection module and the image display module in the multi-channel optical microscopy and multimodal signal acquisition and control system III, wherein the morphologic change and the transit time only need bright field illumination, and position adjustment and bright field illumination adjustment are made by the electric table control module. Single cells loaded with a Ca²⁺/NO/ROS probe need to be excited at the corresponding excitation wavelength (340 nm/550 nm/485 nm) to measure the changes in the concentrations of Ca²⁺/NO/ROS, and excitation light switching is performed by the laser control module.

### Step 3: Data Processing and Analysis

The data processing and analysis system IV processes and analyzes the data of images collected by the image collection module in the multi-channel optical microscopy and multimodal signal acquisition and control system III. The cell morphometry analysis module calculates the degree of cell deformation and the time to pass through the constrained narrow channel array 3-3 as well as the cellular elastic modulus and viscous modulus, and the cellular mechanodynamic modeling module establishes a single-cell mechano-viscoelastic model accordingly. According to the images obtained in step 2, the single-cell kinetic modeling module uses parameter identification methods to acquire the changes in the concentrations of intracellular Ca²⁺/NO/ROS and establish an intracellular second messenger dynamics model. The neural network-based multimodal information fusion unit combines the structures of a CNN and a RNN to construct a deep neural network framework, selects an appropriate neural network structure according to the mechanical characteristics (elastic modulus and viscous modulus) and multimodal data of changes in the concentrations of intracellular Ca²⁺/NO/ROS, establishes a neural network-based multimodal information fusion model, and realizes rapid acquisition of single-cell mechanical properties and signal dynamics characteristic parameters.

### Step 4: Real-Time Cancer Diagnosis and Drug Screening

Loading blood samples into the instrument, repeating steps 1-3, and establishing a health standard database and a cancer cell database of single-cell multimodal spatiotemporal information using the neural network-based multimodal information fusion unit. Loading random blood samples into the instrument, and performing real-time cancer diagnosis through analysis and comparison with databases. Treating tumor cells with pro-apoptotic antitumor drugs, loading the tumor cells into the instrument, and achieving the therapeutic effect of the drugs on cancer cells through analysis and comparison with the healthy cell database, thereby carrying out drug screening.

1. A real-time flow cytometric analyzer of single-cell dynamics combining droplet microfluidics and multimodal optical microscopy, wherein the real-time flow cytometric analyzer of single-cell dynamics comprises a cell/signal loading & acquisition and control system (I), a high-throughput microfluidic single-cell manipulation chip (II), a multi-channel optical microscopy and multimodal signal acquisition and control system (III), and a data processing and analysis system (IV);
the cell/signal loading & acquisition and control system (I) comprises an industrial control computer (2-1), a pressure actuated device (2-2), a liquid storage bottle A (2-3A), a liquid storage bottle B (2-3B), a liquid storage bottle C (2-3C), a micro flow measurement module A (2-4A), a micro flow measurement module B (2-4B) and a micro flow measurement module C (2-4C); the industrial control computer (2-1) is used for controlling the pressure actuated device (2-2) and displaying flow data loaded in the micro flow measurement module A (2-4A), the micro flow measurement module B (2-4B) and the micro flow measurement module C (2-4C); the pressure actuated device (2-2) is respectively connected with the liquid storage bottle A (2-3A), the liquid storage bottle B (2-3B) and the liquid storage bottle C (2-3C), and the outlets of the liquid storage bottle A (2-3A), the liquid storage bottle B (2-3B) and the liquid storage bottle C (2-3C) are respectively connected with the micro flow measurement module A (2-4A), the micro flow measurement module B (2-4B) and the micro flow measurement module C (2-4C) for detecting and feeding back the flow input loaded by the industrial control computer (2-1) to the industrial control computer (2-1); and the outlets of the micro flow measurement module A (2-4A), the micro flow measurement module B (2-4B) and the micro flow measurement module C (2-4C) are respectively connected with an oil phase inlet (3-1A), a biochemical factor buffer solution inlet (3-1B) and a single-cell suspension inlet (3-1C);
the high-throughput microfluidic single-cell manipulation chip (II) comprises an oil phase inlet (3-1A), a biochemical factor buffer solution inlet (3-1B), a single-cell suspension inlet (3-1C), a spiral inertial focusing microchannel (3-2), a constrained narrow channel array (3-3) and a chip outlet (3-4); and the oil phase inlet (3-1A), the biochemical factor buffer solution inlet (3-1B) and the single-cell suspension inlet (3-1C) are converged to a “cruciform” outlet through respective channels and connected with the inlet of the spiral inertial focusing microchannel (3-2), the outlet of the spiral inertial focusing microchannel (3-2) is connected with the inlet of the constrained narrow channel array (3-3), and the outlet of the constrained narrow channel array (3-3) is the chip outlet (3-4);
a single-cell suspension channel connected after the single-cell suspension inlet (3-1C) is composed of a plurality of anticlockwise spiral inertial focusing microchannels, and single cells are sequenced under the action of centrifugal force and fluidic shear stress in the process of single-cell suspension passing through the single-cell suspension channel; the biochemical factor buffer solution inlet (3-1B) and a circular biochemical factor buffer solution channel connected thereafter are located on the outer ring of the single-cell suspension channel, and the biochemical factor buffer solution inlet (3-1B) is symmetrically arranged with the outlet of the circular biochemical factor buffer solution channel; the oil phase inlet (3-1A) and a circular oil phase channel connected thereafter are located on the outer ring of the circular oil phase channel, and the oil phase inlet (3-1A) is symmetrically arranged with the outlet of the circular oil phase channel; and the outlet of the single-cell suspension channel is located in front of the outlet of the circular biochemical factor buffer solution channel, which enables single cells from the outlet of the single-cell suspension channel to mix with biochemical factor buffer solution, and the outlet of the circular biochemical factor buffer solution channel is located in front of the outlet of the circular oil phase channel, which enables the mixture of single cells from the outlet of the circular biochemical factor buffer solution channel and the biochemical factor buffer solution to be encapsulated by an oil phase;
the multi-channel optical microscopy and multimodal signal acquisition and control system (III) comprises an industrial control computer (2-1) and a multi-channel fluorescence microscope (4-1), and the industrial control computer (2-1) is used for measuring multimodal information of single cells and controlling the multi-channel fluorescence microscope (4-1), comprising an image collection module, an image display module, an electric table control module and a laser control module;
the data processing and analysis system (IV) comprises an image data processing module and a data analysis and display module loaded in the industrial control computer (2-1), wherein the image data processing module comprises a cell morphometry analysis module, a cellular mechanodynamic modeling module and a single-cell kinetic modeling module; and the data analysis and display module comprises a neural network-based multimodal information fusion unit, a data display interface unit and a pressure/flow control interface unit.

2. A real-time analytical method for single-cell dynamics using the real-time flow cytometric analyzer of single-cell dynamics combining droplet microfluidics and multimodal optical microscopy according to claim 1, comprising the following steps:
step 1: preparing glycerite, biochemical factor buffer solution and single-cell suspension, and placing in the liquid storage bottle A (2-3A), the liquid storage bottle B (2-3B) and the liquid storage bottle C (2-3C) respectively; controlling the pressure actuated device (2-2) through the pressure/flow control interface unit in the industrial control computer (2-1) to inject the glycerite, the biochemical factor buffer solution and the single-cell suspension into the oil phase inlet (3-1A), the biochemical factor buffer solution inlet (3-1B) and the single-cell suspension inlet (3-1C) of the high-throughput microfluidic single-cell manipulation chip (II) respectively at different flow velocities through the micro flow measurement module A (2-4A), the micro flow measurement module B (2-4B) and the micro flow measurement module C (2-4C); the single-cell suspension is orderly arranged through a plurality of anticlockwise spiral inertial focusing microchannels, the biochemical factor buffer solution passes through the circular channel, and the glycerite passes through the circular channel, which are then converged to a “cruciform” outlet to orderly form droplets encapsulating single cells; in the spiral inertial focusing microchannel (3-2) connected thereafter, the single cells in the droplets and the biochemical factor buffer solution are uniformly mixed and orderly arranged, and the droplets encapsulating the single cells are orderly arranged to deform through the constrained narrow channel array (3-3) and then flow out from the chip outlet (3-4);
step 2: switching on the multi-channel optical microscopy and multimodal signal acquisition and control system (III), adjusting the position of the multi-channel fluorescence microscope (4-1) using the electric table control module in the industrial control computer (2-1), and using the laser control module to switch between the bright field and the laser to take, record and collect images; and using the image collection module in the industrial control computer (2-1) for real-time monitoring of the deformation process and transit time of single cells in the constrained narrow channel array (3-3) and changes in concentrations of intracellular Ca²⁺/ROS/NO and for display in the image display module;
step 3: according to the images taken, recorded and collected by the multi-channel optical microscopy and multimodal signal acquisition and control system (III), using the image data processing module for data processing in the data processing and analysis system (IV): using the cell morphometry analysis module to analyze the deformation process and transit time of single cells passing through the constrained narrow channel array (3-3), and calculating the cellular elastic modulus and viscous modulus; using the cellular mechanodynamic modeling module to establish a single-cell mechano-viscoelastic model; using the single-cell kinetic modeling module to calculate changes in the concentrations of intracellular second messengers and establish an intracellular second messenger dynamics model; using the data analysis and display module for data analysis and display in the data processing and analysis system (IV): using the neural network-based multimodal information fusion unit for deep learning of the obtained cell mechanics information and dynamics information via the neural network to obtain a neural network-based multimodal information model, preparing for subsequent rapid analysis of multimodal information of single cells, and realizing intelligent analysis of single cells; and using the data display interface unit to display all data results;
step 4: loading random blood samples into the real-time flow cytometric analyzer of single-cell dynamics, and obtaining multimodal information of single cells in the samples by the neural network-based multimodal information fusion unit for distinguishing normal cells from cancer cells; and converting the biochemical factor buffer solution into a drug, loading the drug into cells, and repeating steps 1-4, thereby performing drug screening according to the obtained multimodal information of single cells.
